(19) United States
(12) Patent Application Publication
(10) Pub. No.: US 2002/0059754 A1
(43) Pub. Date: May 23, 2002

(54) Gas-production system for a fuel cell system, and method for producing hydrogenous fuel

(76) Inventors: Stefan Boneberg, Beuren (DE); Martin Schaefer, Kirchheim/Teck (DE); Martin Schuessler, Ulm (DE); Erik Theis, Kirchheim/Teck (DE); Matthias Wolfsteiner, Kirchheim/Teck (DE)

Correspondence Address: CROWELL & MORING, L.L.P., Intellectual Property Group, P.O. Box 14300, Washington, DC, 20044-4300, US

(21) Appl. No.: 09/984,178

(22) Filed: Oct. 29, 2001

(30) Foreign Application Priority Data
Oct. 28, 2000 (DE) 100 53 597.6

(51) Int. Cl. C01B 3/26; C10J 3/00; C10K 1/00; C10K 3/00

(52) U.S. Cl. 48/197 R; 423/437.2; 423/651; 48/61; 48/76

(57) ABSTRACT

In a method and apparatus for producing a hydrogenous gas stream for a fuel cell system, the share of CO contained in the gas stream, is reduced by providing one or more selective oxidation stages which preferably are thermally coupled to a reformer for the reforming of hydrocarbons, or to a heat exchanger. In order to supply the fuel cell system, as quickly as possible, with a hydrogenous gas stream having a low share of CO, so that it can be placed in operation at the temperature of the surrounding environment, one or more additional, thermally decoupled, selective oxidation stages is series-connected to the existing selective oxidation stages at the beginning or end of the series, or at intermediate points.

### BACKGROUND AND SUMMARY OF THE INVENTION

This application claims the priority of German patent document 100 53 597.6 filed Oct. 28, 2000, the disclosure of which is expressly incorporated by reference herein.

The invention relates to a method and apparatus for producing a hydrogenous gas stream as a fuel for a fuel cell system. In order to reduce the amount of carbon monoxide contained in the gas stream, one or more selective oxidation stages are provided, which are thermally coupled preferably to a reformer designed to reform hydrocarbons, or to a heat exchanger producing hydrogenous fuel for a fuel cell system.

Known gas-production systems are used, for example, in vehicles driven by fuel cells, to supply hydrogen as the fuel required for operation of the fuel cell. To accomplish this, for example, methanol is reformed in a reformer assembly, producing carbon dioxide and hydrogen in accordance with the following reaction:

CH₃OH+H₂O→CO₂+3H₂

With the addition of air/oxygen, this process can be supported by the exothermic conversion of the hydrocarbon. A hydrogen-rich gas is also produced via the partial oxidation of the hydrocarbon.

In this conversion of methanol, carbon monoxide is also formed in intermediate stages, hence the reformate contains primarily hydrogen, carbon dioxide, water (vapor) and carbon monoxide.

If the reformate is to be used in a fuel cell, the CO concentration, which is approximately 1%, must be reduced to less than 40 ppm, since carbon monoxide drastically reduces the efficiency of polymer-membrane fuel cells.

To remove CO in a hydrogen-rich atmosphere, a water-gas shift reaction and the selective oxidation of CO in fixed-bed reactors may be used, with corresponding selective catalysts. In this reaction, the catalytic substance used is in the form of pellets or balls as the bed in the reaction tube, in the presence of or in the form of a coating on the inner surface of heat-exchanger channels.

In the water-gas shift reaction

CO+H₂O→CO₂+H₂

carbon monoxide is catalytically converted to carbon dioxide using water vapor. Thus, a reduction of the CO concentration in the reformate to approximately 0.5% is achieved. To further reduce this concentration, the reformate is fed through one or more oxidation stages. In these stages, carbon monoxide is converted to carbon dioxide, in keeping with

CO+1/2O₂→CO₂

wherein the share of carbon monoxide in the reformate can be reduced far below 40 ppm.

U.S. Pat. No. 5,271,916 discloses a multistage, selective oxidation process, in which the reformate that exits a shift reactor is injected with oxygen/air, and is fed through a heat exchanger, in order to hold the temperature within a range of 160° to 175° C. In parallel catalytic reaction chambers, the adiabatic exothermic conversion of the carbon monoxide in the reformate takes place. In a second heat exchanger, the temperature of the produced gas mixture is cooled to approximately 190° C., and the gas mixture, together with the added oxygen, is fed through a second reaction stage. Afterward, this is followed again by a cooling process, to prevent a balanced reaction in which carbon monoxide would again be produced. The hydrogen-rich gas that is fed to the fuel cell contains less than approximately 0.01% carbon monoxide.

The use of a series of selective Co oxidation stages, each involving the controlled addition of oxygen, is disclosed in German patent documents DE-4334983A1 and DE-19544895C1. In the latter, by regulating the quantity of oxidizing gas flow, the build-up of heat in the exothermic CO oxidation reaction can be directly influenced, such that a preliminary cooling of the gas mixture exiting the reformer prior to its introduction into the selective oxidation stage can be omitted.

A multistage selective oxidation of carbon monoxide in plate-type heat exchangers is described in International patent document WO97/25752. The reformate, to which oxygen has been added, is fed through channels, formed from corrugated metal coated with a catalyst. Parallel to this gas flow, and separated from it by flat metal surfaces, a cooling agent is fed through, in order to keep the temperature in the oxidation stage from rising any higher than 190° C. (At higher temperatures, the hydrogen contained in the reformate becomes increasingly oxidized.) Upon exiting the first selective oxidation stage, the cooling agent and the reformate are again cooled via a heat exchanger, after which they are fed to the next selective oxidation stage, in which the share of carbon monoxide is reduced to approximately 10 ppm, and the outlet temperature is approximately 80° C. Additional selective oxidation stages designed as heat exchangers are known from European patent documents EP-0616733B1 and EP-0720781B1, in which the temperature or the concentration of oxygen in the reaction stream is held constant.

The numerous known devices and methods for the selective oxidation of carbon monoxide such as described above are concerned with operation of the systems once they have reached operating temperature. However, this carries with it the above-mentioned problems of maintaining the temperature of the catalyst within a predetermined range in which the catalyst will perform optimally, and maintaining reaction temperatures within a range in which carbon monoxide, but not hydrogen, will be oxidized. For this purpose, a continuous cooling of the CO oxidation stages is necessary.

Upon start-up of a fuel cell system, however, it is necessary to bring the CO oxidation stages to operating temperature as quickly as possible, to provide the fuel cell with a reformate having low CO concentrations from the very start.

To solve this problem, it was proposed in Japanese patent document JP0010029802A (application number: 1996 202803) that the catalyst in the selective oxidation stage be pretreated with a gas composed primarily of hydrogen, at a temperature above

50° C., which will react in that stage without the addition of air. Along the same lines, it was proposed in Japanese patent document JP0008133701A (application number: 1994 288612) that, for cold starts or following interruptions in operation, surplus oxidizing agents (air) be continuously fed to the selective oxidation reactor if the temperature is below operating temperature for the catalyst. With this method, hydrogen is also oxidized in addition to the carbon monoxide, causing the temperature to rise rapidly as a result of the exothermic reaction. After reaching activation temperature for the catalyst, the addition of oxidizing agent is controlled such that an optimum conversion of the carbon monoxide will follow.

This proposed method for the cold start of CO oxidation stages utilizes a rapid increase in temperature resulting from the exothermic conversion of hydrogen. However, this technique leads to a reduction in the share of hydrogen present in the reformate, so that the fuel cell cannot be adequately supplied with fuel during the start-up phase, which reduces the efficiency of the system.

The object of the present invention is to provide a generic gas-production system that will have the shortest possible time-delay for the fuel cell system, with the necessary low CO concentration, and a sufficient concentration of hydrogen.

This and other objects and advantages are achieved by the gas generating method and apparatus according to the invention in which, to achieve the selective oxidation of carbon monoxide upon start-up of the gas production system, one or more additional, thermally decoupled, selective oxidation stages are series-connected at either the inlet or the outlet sides of the thermally coupled selective oxidation stage or stages. If the selective oxidation is to be performed using a series of catalyst assemblies, additional thermally decoupled oxidation stages may also be added between two catalyst assemblies, in accordance with the invention. The additional, selective oxidation (Selox) stages are designed such that a start-up is possible even at low temperatures. This can be fundamentally achieved in that the reaction proceeds under adiabatic or near adiabatic conditions, such that the additional Selox stage is thermally insulated. This results in a rapid increase in temperature in the start-up phase, causing the catalyst to quickly reach its normal level of operating activity.

Especially immediately following a cold start, the additional Selox stages can be heated, for example electrically via a glow plug. When additional adiabatic Selox stages are used, this supplemental heat source can be switched off once the operating temperature has been reached.

In accordance with the invention, in the case of a cold start, or following lengthy interruptions in operation, the function of CO oxidation is taken over by the additional (adiabatic) Selox stages, while during normal operation CO oxidation proceeds in the stages, most of which are coupled to a reformer or heat exchanger. In the case of a cold start, the coupled oxidation stages serve to cool the reformate exiting the additional, thermally decoupled Selox stage, in order to allow a sufficient quantity of gas to be adiabatically converted in the subsequent adiabatic Selox stage (assuming one is present). In this process, the coupled Selox stages are warmed by the hot exhaust gas, and increasingly begin to perform their actual task.

Thus, with the invention, hydrogenous gas that is produced in series-connected partial oxidation and/or reform stages, or that originates from a reformate storage vessel, can be used immediately in the generation of electric power in a fuel cell.

The additional, thermally decoupled Selox stages can be heated by injection of additional fuel and/or air, so that heating occurs before the reformate is available for use, greatly accelerating the firing up of the main stage (coupled Selox stages).

The additional Selox stages specified in the invention may be supplied via the injection of air into the Selox components coupled at the start of the series, since no conversion can take place in these components as long as the temperature of the catalyst lies below the firing-up temperature. Of course, an additional injection of air may also be incorporated prior to each additional thermally decoupled stage.

The additional decoupled stages may also be integrated into the components coupled at the start of the series (Selox with reformer or heat exchanger). In this case, integration in the collecting channels of the series-connected components has proven particularly advantageous.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic depiction of a gas-production system according to the invention, with a preliminary stage for selective CO oxidation connected in series prior to the main stage; and

FIG. 2 shows a further gas production system according to the invention, with additional stages for selective CO oxidation connected at the beginning and end of the series, and at intermediate points.

### DETAILED DESCRIPTION OF THE DRAWINGS

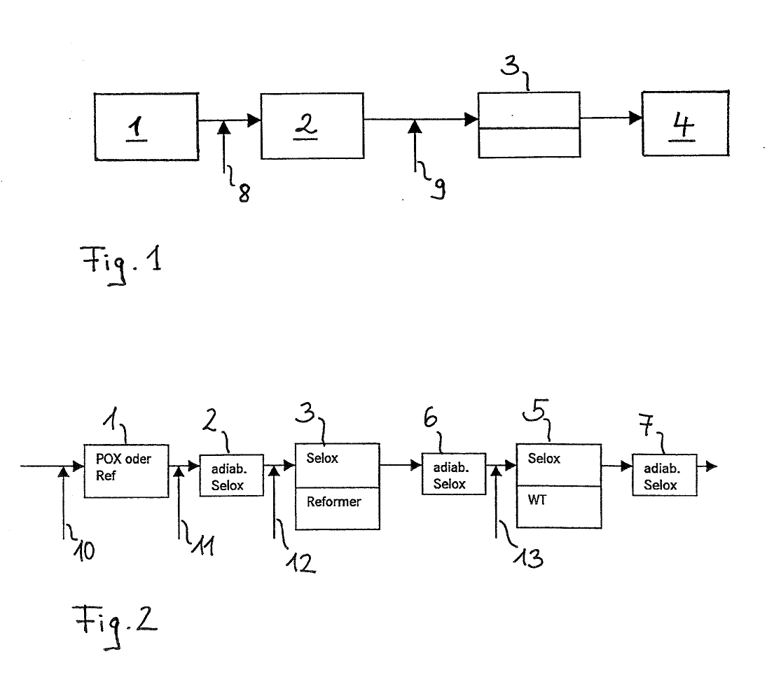

The gas production system as illustrated in FIG. 1 is equipped with a reformer 1 that produces a hydrogenous reformate from methanol, using known methods. (For the sake of simplicity, heat exchangers and shift reactors, which may then be connected in series and serve to reduce the CO concentration, are not illustrated here.) The reformate may originate from a reformate storage vessel that stores the reformate from previous operating cycles, or from a reforming unit. In this exemplary embodiment, the hydrogenous reformate serves to supply a fuel cell system with fuel (hydrogen) to drive a motor vehicle. To this end, the hydrogenous reformate is fed to the anode side of the fuel cell system, while (air) oxygen is fed to the cathode side. In the fuel cell system, the electrochemical conversion of the hydrogen to water follows, with the generation of electrical power. This electrical power is then supplied to an electric motor and/or other consumers in the motor vehicle.

The direct introduction of reformate would result in a poisoning of the fuel cells due to the CO contained therein, even after being purified in a shift reactor. For this reason it is necessary to reduce the CO concentration to less than 40 ppm, preferably less than 10 ppm. For this purpose, selective oxidation catalysts are normally used, which may be connected in a multistaged series, in order to optimize the oxidation process. Between the individual stages, oxygen (air) is introduced, in order to provide the oxygen concentration necessary for each stage to be optimally regulated. In FIG. 1, a main stage of this type for the selective CO oxidation is indicated by the number 3. Air is injected via the line 9. The main stage 3, with the air injection line 9, may be designed to be multistaged, as indicated above.

The selective oxidation stages are thermally coupled with reformer stages or heat exchangers.

A gas-production system of this type carries with it the serious disadvantage that upon start-up of the system (cold start or interrupted operation) selective oxidation can only effectively take place when the catalyst has reached the necessary operating temperature of at least 100° C. Prior to this point, the reformate cannot be used to generate electrical power for the fuel cell 4, as the fuel cell would become poisoned. For this reason, in accordance with the invention, the main stage 3 is preceded by a preliminary stage 2 designed for selective CO oxidation, which is operated adiabatically, and thus starts very quickly during a cold start. During the start-up phase, in which reformate is formed in the reformer 1 connected at the beginning of the series, the preliminary stage 2 takes over the function of the main Selox stage. At the same time, energy is introduced into the actual main stage 3 (via the reformate heated by exothermic CO oxidation), in order to guarantee a firing-up of the reaction there. In this case, the main stage 3 is designed as a plate-type or shell-and-tube heat exchanger, so that the catalyst can be constantly cooled, thus keeping the temperature of the catalyst below approximately 180° C. If this temperature is exceeded, hydrogen, which is needed as the fuel, will also be oxidized.

It may be advantageous to preheat the preliminary stage 2, before the reformate is made available, for example, electrically, or by injecting additional fuel and/or air via the line 8. The resulting exothermic reactions would then release heat, greatly accelerating the firing-up of the main stage 3.

FIG. 2 shows a second exemplary embodiment of the gas-production system according to the invention, with components similar to those in FIG. 1 having the same numbers. The hydrogenous gas originates from a reformer 1, a partial oxidation unit (POX), or a reformate storage vessel. In this exemplary embodiment, reformate is oxidized selectively in two series-connected stages 3 and 5, in order to reduce the CO concentration in the reformate. Stage 3 is comprised of a selective oxidation stage coupled to a reformer, while stage 5 is a Selox stage coupled to a heat exchanger. Connected to the first oxidation stage 3 is a preliminary stage 2, in the form of an adiabatic, selective oxidation reactor, as in the above-described exemplary embodiment. The air line 11 supplies the preliminary stage 2 with the necessary oxygen. Further, an additional adiabatic, selective oxidation reactor 6 is connected between the two stages 3 and 5. This intermediate stage 6 receives the necessary atmospheric oxygen via the air-injection line 12 of the thermally coupled Selox component 3, connected in front of the intermediate stage. Finally, in accordance with the invention, the second main stage 5 is followed in series by an additional adiabatic Selox stage 7. The reformate that exits this last stage 7 may be run through a cooling assembly prior to entering the fuel cell system 4, in order to limit the inlet temperature of the fuel cell, and to prevent a renewed formation of carbon monoxide.

In a cold start of the gas-production system according to the invention, the temperatures of the catalyst in the two main stages 3 and 5 are initially too low to guarantee an adequate reduction in the CO concentration in the reformate. For this reason, in accordance with the invention, three additional, thermally decoupled Selox stages 2, 6, and 7 are connected in front of, between, and behind these two stages. In a cold start, the coupled Selox stages 3 and 5 serve to cool the reformate, in order to allow a sufficient quantity of air to again be adiabatically converted in the subsequent Selox stage 6 or 7. For this purpose, the coupled stages 3 and 5 are heated by the hot exhaust gas from the adiabatic stages 2 and 6, and increasingly take on their actual intended task. During normal operation, CO oxidation is achieved in the coupled main stages 3 and 5.

To further improve the cold start properties, one of the additional adiabatic selective oxidation reactors, preferably the preliminary stage 2, can be heated electrically, to bring the catalyst to its necessary operating temperature as quickly as possible. It is also possible to introduce heat by injecting air and/or fuel via the air-inlet line 11.

It is not necessary for the two adiabatic Selox stages 6 and 7 connected behind the main stages 3 and 5, respectively, to have their own air inlet lines, since during the cold start phase, oxygen introduced via the air lines 12 and 13 into the main stages 3 and 4 cannot be converted.

The heated reformate exiting the additional adiabatic Selox units 2 and 6 can heat the catalysts in the main stages 3 and 5, thus bringing them more rapidly to the necessary operating temperature. At the same time, the reformate is cooled, so that in the subsequent adiabatic Selox stage 6 or 7 a sufficient quantity of air can again be converted.

It has proven advantageous to integrate the additional adiabatic Selox stages 6 and 7 into the collecting channel of the preceding main stage 3 or 5.

With the invention, improved cold start properties for a fuel cell system supplied with a hydrogen-rich reformate are guaranteed, effectively preventing a poisoning of the fuel cell caused by a concentration of CO that is too high. At the same time, the invention avoids the use of hydrogen to improve cold start properties, so that the fuel cell system can be supplied immediately with the entire available hydrogen concentration.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Apparatus for generating a hydrogenous gas stream for a fuel cell system, wherein:
for reducing an amount of CO present in the gas stream, at least one selective oxidation stage is provided, thermally coupled to one of a hydrocarbon reformer and a heat exchanger;
for selective oxidation of carbon monoxide upon start-up of the gas-production system, at least one additional, thermally decoupled, selective oxidation stage is connected at at least one of a beginning, intermediate points and an end of the apparatus, relative to a gas flow direction.

2. The apparatus according to claim 1, wherein at least one of the additional selective oxidation stages is thermally insulated.

3. The apparatus according to claim 1, wherein at least one of the additional selective oxidation stages can be heated electrically.

4. The apparatus according to claim 1, wherein at least one of the additional selective oxidation stages is coupled to an additional intake line for one of air and fuel.

5. A method for producing a hydrogenous gas stream for a fuel cell system, said method comprising:
reducing a share of CO present in the gas stream by catalytically oxidizing CO in at least one stage; and
during a start-up phase, at low temperatures, selectively, catalytically oxidizing said CO present in the gas stream, at an independently adjustable temperature.

6. The method in accordance with claim 5, wherein the carbon monoxide is adiabatically, selectively oxidized during said start up phase.

7. The method in accordance with claim 5, wherein temperature of the gas stream during a beginning phase of selective oxidation is adjusted via electric heating.

8. The method in accordance with claim 5, wherein temperature of the gas stream is adjusted by injection of one of air and fuel to the gas stream to be selectively oxidized.

9. The method in accordance with claim 5, for selective, catalytic oxidation at an independently adjustable temperature, air fed into a series-connected selective, catalytic oxidation stage which, due to the low temperature in the start-up phase, has a low air conversion rate.

10. The method in accordance with claim 5, wherein a selectively oxidized gas stream produced in the start-up phase is used to heat remaining selective oxidation stages.

11. Apparatus for providing a hydrogenous gas stream for a fuel system, comprising:
a source for a hydrogenous gas stream containing carbon monoxide;
at least one carbon monoxide selective oxidation stage which is connected to receive said gas stream and is thermally coupled to one of a hydrocarbon reformer and a heat exchanger; and
at least one additional thermally decoupled selective oxidation stage which is connected at at least one of a beginning, intermediate points and an end of said gas stream, and is operable upon startup of said apparatus.

12. The apparatus according to claim 11, wherein at least one of the additional selective oxidation stages is thermally insulated.

13. The apparatus according to claim 11, wherein at least one of the additional selective oxidation stages can be heated electrically.

14. The apparatus according to claim 11, wherein at least one of the additional selective oxidation stages is coupled to an additional intake line for one of air and fuel.
